(19) United States
(12) Patent Application Publication
(10) Pub. No.: US 2017/0104308 A1
(43) Pub. Date: Apr. 13, 2017

(54) SOLID-STATE LASER DEVICE BASED ON A TWISTED-MODE CAVITY AND A VOLUME GRATING

(71) Applicant: II-VI SUWTECH, INC., Shanghai (CN)

(72) Inventors: Jintao YANG, Shanghai (CN); Shaofeng ZHANG, Shanghai (CN); Xiaojing TAN, Shanghai (CN); Dashan LI, Shanghai (CN)

(73) Assignee: II-VI SUWTECH, INC., Shanghai (CN)

(21) Appl. No.: 15/200,207

(22) Filed: Jul. 1, 2016

(30) Foreign Application Priority Data
Jul. 3, 2015 (CN) 201510388076.0

(51) Int. Cl. H01S 3/109; H01S 3/16; H01S 3/08

(52) U.S. Cl. CPC H01S 3/109; H01S 3/08059; H01S 3/08009; H01S 3/1611; H01S 3/1643

(57) ABSTRACT

The present invention describes a solid-state laser device based on a twisted-mode cavity and a volume grating, which comprises: a pumping source for emitting pump light; an optical resonator, which comprises: a cavity mirror, which is a high reflective mirror for introducing the pump light into the optical resonator; an output coupler, which is a reflective volume Bragg grating spaced away from the cavity mirror; a twisted-mode cavity, which includes: a first wave plate, located at one side close to the pumping source; a second wave plate, located at another side far away from the pumping source; a gain medium, located between the first wave plate and the second wave plate for generating a fundamental frequency laser; a focusing unit, located between the pumping source and the optical resonator for focusing the pump light emitting from the pumping source to the optical resonator.

This application claims priority to a Chinese patent application (Chinese Appl. No. 201510388076.0, entitled “A SOLID-STATE LASER DEVICE BASED ON A TWISTED-MODE CAVITY AND A VOLUME GRATING”, filed on Jul. 3, 2015), the contents of which are incorporated herein by reference in its entirety.

### TECHNICAL FIELD

The present invention relates to a solid-state laser device, especially a solid-state laser device with intra-cavity frequency doubling, narrow line-width output and single longitudinal mode operation.

### BACKGROUND

A solid-state laser device typically comprises a laser diode, an optical resonator, a gain medium and other optical elements for optimizing the beam quality, or further comprises nonlinear crystals for wavelength conversion. Solid-state lasers can be realized in a compact structure (<10 cm) and generates middle and high power output with high beam quality. Thus, solid-state lasers have been widely applied to optical storage, color display, laser projectors, machine vision, biotechnology, medical diagnostics and other fields.

Please refer to FIG. 1, which is a schematic diagram showing the structure of a solid-state laser in prior art. As shown in FIG. 1, the solid-state laser includes a pumping source 101, an optical resonator and a focusing unit 102. The optical resonator includes: a cavity mirror 103, an output coupler 105 and a gain medium 104. The focusing unit 102 is placed between the pumping source 101 and optical resonator, and can focus the pump light emitted from the pumping source 101 to the cavity mirror 103. The lasing light 106 can be generated from the optical resonator.

Generally, the solid-state laser device uses partially reflective mirror or dichroic mirror as the output coupler. However, if the gain spectrum of the gain medium comprises a plurality of spectral lines which are very close to each other and have different gains, or the gain spectrum is broad and continuous, it won't be applicable any longer to employ traditional output coupler to select the required laser wavelength, mainly because both partially reflective mirrors and dichroic mirrors with regular coating can't realize sufficient intensity attenuation for the undesired adjacent spectral lines. If the conventional output coupler is used, its film structure should be built through a complex design, and usually the film thickness is greater, which increases not only the technological difficulty but also the cost of the coating greatly, especially for the solid-state laser device with the gain medium made of Nd:YAG, because the Nd:YAG crystal has more than 20 emission lines, some of which are with small wavelength interval, such as 1053 nm, 1061 nm, 1064 nm, 1073 nm, 1078 nm, 1112 nm and 1122 nm. In order to solve the above problem, an optical etalon, a dichroic filter, a Lyot filter or a dispersive prism can be inserted into the optical resonator to select the required wavelength. Although these optical elements can effectively select the required wavelength, they will also bring some side effects, such as increasing the intra-cavity losses and making the resonator structure more complex, which cause the decrease of the laser output power and instability of the laser operation.

In addition, a solid-state laser device commonly uses standing-wave cavity as the optical resonant cavity. Due to the presence of the intra-cavity standing wave mode, the gain will be cyclically saturated along the axial direction of the gain medium, and result in spatial hole burning, which may seriously affect the running of single longitudinal mode and the stability of laser output. In order to eliminate the phenomenon of spatial hole burning, the usual solution is to move a certain cavity mirror by using electro-optical modulator, so that the standing wave mode can move in the gain medium, thereby avoiding a stable periodic gain saturation. However, the presence of electro-optical modulator makes the structure of resonant cavity more complex, which will affect the laser stability. A more practical approach is to use unidirectional ring resonator, in which the optical wave circulates and transmits along a single direction so as to avoid the appearance of standing wave. The ring resonator has two directions, if the transmission loss in one direction is more than in the other direction, then the laser will be running along the direction with lower loss. This kind of loss difference can be realized by inserting a Faraday rotator and a half-wave plate, which will generate polarization dependence and polarization rotation in the transmission direction, so that light waves will keep the polarization constant while transmitting along one direction and polarization rotated while transmitting along the other direction. However, the insertion of these optical elements will increase intra-cavity losses and thereby increase the light emission threshold. Furthermore, the unidirectional ring resonator generally occupies a larger volume, compared to the standing wave resonator, thus it is difficult to be implemented in a compact device required by the various applications mentioned above.

### SUMMARY

For overcoming the defects in a common solid-state laser device with narrow line-width output and single longitudinal mode operation, an object of the invention is to provide a solid-state laser device based on a twisted-mode cavity and a volume grating, which can realize a single longitudinal mode operation and narrow line-width output by arranging a twisted-mode cavity and using a reflective volume Bragg grating as the output coupler.

One aspect of the present invention provides a solid-state laser device based on a twisted-mode cavity and a volume grating, comprising:

a pumping source for emitting pump light;

an optical resonator, which comprises:
a cavity mirror, which is a high reflective mirror for introducing said pump light into said optical resonator;
an output coupler, which is a reflective volume Bragg grating spaced away from said end mirror;
a twisted-mode cavity, which includes:
   a first wave plate, located at one side close to said pumping source;
   a second wave plate, located at another side far away from said pumping source;
a gain medium, located between said first wave plate and said second wave plate for generating a fundamental frequency laser;
and a focusing unit, located between said pumping source and said optical resonator for focusing said pump light emitting from said pumping source to said optical resonator.

As a further aspect, said cavity mirror has reflectivity above 99.8% for the selected fundamental frequency laser and second harmonic light thereof.

As a further aspect, said cavity mirror is a lens or an optical element, of which the incident surface is provided with a high reflective film.

As a further aspect, the lateral surface of said first wave plate which is near said pumping source is provided with a high reflective film, and said first wave plate serves as said cavity mirror.

As a further aspect, said optical resonator further comprises a frequency doubling crystal for converting said fundamental frequency light to its second harmonics.

As a further aspect, said gain medium, said frequency doubling crystal, said first wave plate and said second wave plate are glued together by optical cement to reduce intra-cavity loss.

As a further aspect, said frequency doubling crystal is placed between said first wave plate and said gain medium or between said gain medium and said second wave plate.

As a further aspect, said frequency doubling crystal is located outside of the twisted-mode cavity.

As a further aspect, said frequency doubling crystal is located outside of said twisted-mode cavity and at the side near said pumping source, and said frequency doubling crystal, as said cavity mirror, is provided with a high reflective film on its lateral surface near said pumping source.

As a further aspect, said frequency doubling crystal is a type I phase matching crystal.

As a further aspect, said cavity mirror is a concave mirror, and the lateral surface of said concave mirror which is near said pumping source is provided with an anti-reflection film, and the lateral surface of said concave mirror which is far away from said pumping source is concave and provided with a high reflective film, a partially reflective film, and an anti-reflection film.

As a further aspect, said optical resonator is a V-type resonator, and further comprises a reflective mirror via which the light is reflected to said output coupler.

As a further aspect, both said first wave plate and said second wave plate are quarter wave plates.

As a further aspect, the direction of fast/slow axis of said first wave plate and said second wave plate are adapted with the phase matching type and the direction of optical axis of said frequency doubling crystal.

As a further aspect, said pumping source is a solid state laser, a semiconductor laser or a gas laser.

As a further aspect, the reflective Bragg wavelength of said reflective volume Bragg grating is the same as that of the fundamental frequency laser.

As a further aspect, the reflective Bragg wavelength of said reflective volume Bragg grating is correspondent to the center wavelength of one separated gain spectral line of said gain medium or one wavelength of continuous gain spectrum of said gain medium.

As a further aspect, said reflective volume Bragg grating has a reflectivity above 99.5% for the selected fundamental frequency laser.

As a further aspect, the surface of said reflective volume Bragg grating is coated with a film which is anti-reflective for the selected fundamental frequency laser and second harmonic light thereof.

As a further aspect, said gain medium has separated gain spectral lines or continuous gain spectrum.

As a further aspect, said gain medium is neodymium-doped yttrium aluminum garnet (Nd:YAG), neodymium-doped yttrium vanadium (Nd:YVO₄), titanium-doped sapphire (Ti:sapphire), or chromium-doped magnesium olivine (Cr:Mg₂SiO₄).

As a further aspect, said frequency doubling crystal is an optically nonlinear crystal or a periodically poled crystal, which can convert the fundamental frequency laser into its second harmonic.

The present invention discloses a solid-state laser device, which combines a twisted-mode cavity and a reflective volume Bragg grating to realize the single longitudinal mode operation and narrow line-width output. Wherein, the twisted-mode cavity can be used for eliminating the phenomenon of spatial hole burning, and the reflective volume Bragg grating can be used as an output coupler and also to select the required wavelength in very high accuracy. That is to say, the narrow line-width property is realized by using the reflective volume grating as an output coupler, and single longitudinal mode operation can be guaranteed by combining the twisted-mode cavity and the reflective volume grating, and using the twisted-mode cavity, instead of the standing wave cavity, can effectively eliminate spatial hole burning to ensure the single longitudinal mode operation.

It should be noted that, although both the twisted-mode cavity and the reflective volume Bragg grating pertain to prior art, the present invention combines the twisted-mode cavity and the reflective volume Bragg grating together to implement that any wavelength can be selected in any gain spectrum for the laser oscillation, and also to ensure a stable single longitudinal mode operation and narrow line-width output, with which all the properties of ring resonator laser in larger volume can be realized in a smaller and more compact structure. In addition, there is a frequency doubling crystal inserted in the optical resonator, which can generate second harmonic without “green noise”. The solid-laser device has advantages of high stability, high reliability, good beam quality, low noise and so on.

### BRIEF DESCRIPTION OF THE DRAWINGS

FIG. 1 is a schematic diagram of the solid-state laser device of prior art;

FIG. 2 is a schematic diagram of the solid-state laser device according to the first embodiment of present invention;

FIG. 3 is a schematic diagram of the solid-state laser device according to the second embodiment of present invention;

FIG. 4 is a schematic diagram of the solid-state laser device according to the third embodiment of present invention;

FIG. 5 is a schematic diagram of the solid-state laser device according to the fourth embodiment of present invention.

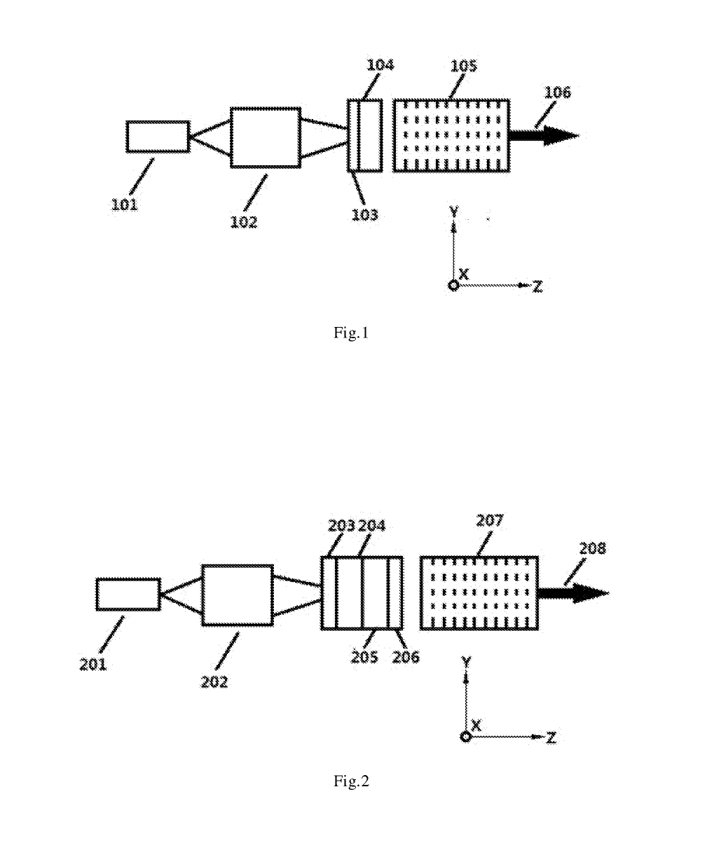

### DETAILED DESCRIPTION

According to the innovative spirit of present invention, a solid-state laser device based on a twisted-mode cavity and a volume grating, comprising: a pumping source for emitting pump light; an optical resonator, which comprises: a cavity mirror, which is a high reflective mirror for introducing the pump light into the optical resonator; an output coupler, which is a reflective volume Bragg grating spaced away from the cavity mirror; a twisted-mode cavity, which includes: a first wave plate located at one side close to the pumping source and a second wave plate located at another side far away from the pumping source; a gain medium, placed between the first wave plate and second wave plate for generating a fundamental frequency laser; and a focusing unit, positioned between the pumping source and the optical resonator for focusing the pump light emitting from the pumping source to the optical resonator.

Hereinafter, the technical contents of present invention will be further described with reference to the accompanying drawings and the embodiments as follows.

### The First Embodiment

Please refer to FIG. 2, which shows a schematic diagram of the solid-state laser device according to the first embodiment of the present invention. In the preferred embodiment shown in FIG. 2, the solid-state laser device comprises: a pumping source 201, an optical resonator and a focusing unit 202.

A pumping source 201 is used for emitting pump light. The pumping source 201 can be a solid status laser, a semiconductor laser or a gas laser. Preferably, the pumping source 201 may be a pumping laser diode, which may be a semiconductor laser diode with emission wavelength of 808 nm.

The optical resonator includes an cavity mirror, an output coupler 207, a twisted-mode cavity, a frequency doubling crystal 204, and a gain medium 205.

The cavity mirror can be a high reflective mirror used for introducing pump light into the optical resonator. Preferably, the high reflective mirror has a reflectivity above 99.8% for the selected fundamental frequency laser and its second harmonic. The cavity mirror can be a lens or an optical element with its surface provided with a high reflective film.

The twisted-mode cavity is placed between the cavity mirror and the output coupler 207. The twisted-mode cavity comprises the first wave plate 203 and the second wave plate 206. The first wave plate 203 is located at one side of the twisted-mode cavity close to the pumping source 201 and the second wave plate 206 is located at another side of the twisted-mode cavity far away from the pumping source, which are used for changing the direction of polarization of the optical vector.

Preferably, the first wave plate 203 and the second wave plate 206 are quarter-wave plates. In order to make the polarization of the optical vector after a round-trip transmission to meet self-consistent conditions, the light outside of the two quarter-wave plates must be linearly polarized, and the light between the two quarter-wave plates must be circularly polarized. The two lights propagating face-to-face will generate linearly polarized electric field vector rotating between the two quarter-wave plates by means of interference, and thus forming a vortex of optical electric field vector. The strength of the electric field vector at any point in the optical resonator, including any point in the gain medium, is the same, which also makes the gain saturation at any point the same, thus avoid the occurrence of spatial hole burning.

In the embodiment shown in FIG. 2, the first wave plate 203 serves as the high reflective mirror, of which the lateral surface near the pumping source 201 is provided with a high reflective film. The first wave plate 203 is a quarter-wave plate for lights with a wavelength of 1122.2 nm and is half-wave plate for lights with a wavelength of 561.1 nm. The optical axis of the first wave plate 203 is in the plane where the X-axis and Y-axis of the coordinate system shown in FIG. 2 and forms an included angle of 45 degree with X-axis. The incident surface of the first wave plate 203 is coated with a high reflective film which has a reflectivity above 99.8% for lights with wavelengths of 1122.2 nm and 561.1 nm, partially reflective film which has a reflectivity below 40% for lights with wavelengths of 946 nm and 1064 nm, and an anti-reflective film which has a reflectivity below 1% for lights with a wavelength of 808 nm.

The second wave plate 206 is a quarter-wave plate for lights with a wavelength of 1122.2 nm and a half-wave plate for lights with a wavelength of 561.1 nm. The optical axis of the second wave plate 206 is in the plane where the X-axis and Y-axis of the coordinate system shown in FIG. 2 and is along the direction of the Y-axis. In order to reduce the loss in the twisted-mode cavity, the incident surface of the second wave plate 206 is coated with an anti-reflective film below 0.2% for all lights.

The gain medium 205 is located between the first wave plate 203 and the second wave plate 206 for generating the fundamental frequency laser. Preferably, the gain medium 205 can be any one selected from neodymium-doped yttrium aluminum garnet (Nd:YAG), neodymium-doped yttrium vanadium (Nd:YVO₄), titanium-doped sapphire (Ti:sapphire), or chromium-doped magnesium olivine (Cr:Mg₂SiO₄). In the preferred embodiment shown in FIG. 2, the gain medium 205 is 1.1% doped Nd:YAG (Nd:Y₃Al₅O₁₂) crystal. It should be noted that the solid-state laser device based on a twisted-mode cavity and a volume grating according to the first embodiment of present invention can not only select the wavelength in the medium (for example, neodymium-doped yttrium aluminum garnet (Nd:YAG)) with separated gain spectrum line, but also select the wavelength in the medium with continuous gain spectrum (for example, chromium doped forsterite (Cr:Mg₂SiO₄)). Thus, the gain medium 205 can be a medium with separated or continuous gain spectrum. In this embodiment, the solid-state laser device based on a twisted-mode cavity and a volume grating preferably select one wavelength at 1064 nm in gain medium 205 of neodymium-doped yttrium aluminum garnet (Nd:YAG). And in other alternative embodiments, the solid-state laser device based on a twisted-mode cavity and a volume grating can also select the wavelength of which the strength is one magnitude lower, such as 1122.2 nm. Since the solid-state laser device based on a twisted-mode cavity and a volume grating can select any wavelength in any gain spectrum for laser oscillation, all of these alternative embodiments can be implemented, which will not be repeated here. As shown in FIG. 2, the frequency doubling crystal 204 is placed between the first wave plate 203 and the gain medium 205. The frequency doubling crystal 204 is used for converting the fundamental frequency laser into its second harmonic, and the maximum second harmonic output may be got by adjusting the phase matching. The frequency doubling crystal 204 can be optically nonlinear crystals, periodically poled crystals, or other crystals which can convert fundamental frequency laser to its second harmonic. Preferably, the frequency doubling crystal 204 is a KTP (KTiOPO₄) crystal, of which the azimuth is 0 degree, and the z-axis is in the plane where the X-axis and Z-axis of the coordinate system shown in FIG. 2, and forms an included angle of 75.4 degrees with the Z-axis, which is the phase matching angle of fundamental frequency laser at 1122.2 nm in KTP crystal. The direction of fast/slow axis of the first wave plate 203 and the second wave plate 206 are adapted with the type of phase matching and the direction of optical axis of the frequency doubling crystal. In some alternative embodiments, the frequency doubling crystal 204 can also be located between the gain medium 205 and the second wave plate 206. These embodiments can also be implemented, which will not be repeated here.

Further, in the preferred embodiment shown in FIG. 2, the gain medium 205, the frequency doubling crystal 204, the first wave plate 203 and the second wave plate 206 are glued together by optical cement to reduce intra-cavity loss.

The output coupler 207 and the twisted-mode cavity are spaced. In a preferred embodiment of the present invention, the output coupler 207 is a reflective volume Bragg grating.

Volume Bragg grating is produced from photo- and thermal-refractive glasses. When the photo- and thermal-refractive glasses are under UV irradiation and a subsequent heat treatment, the permanent change of periodic refractive index will be generated in the glasses to form a volume grating with phase diffraction. When the wavelength of incident light satisfy the Bragg condition on grating, the maximum diffraction rate will occur on this wavelength, which is called Bragg wavelength or center wavelength of volume Bragg grating. For most of the volume Bragg grating, its Bragg wavelength accuracy can be controlled within 0.1 nm to 0.5 nm, and FWHM (full width at half maximum) precision of the corresponding Bragg wavelength spectrum can be controlled within 0.1 nm to 0.3 nm. Volume Bragg grating has a very low light absorption and scattering for light in the range of visible to near infrared, which makes its damage threshold up to 10 KW/cm² for continuous light and up to 10 J/cm² for pulse light. According to the data provided by OptiGrate which is a world-renowned manufacturer for volume Bragg grating, the volume Bragg grating produced by this company can offer 20 picometers (10⁻¹² meters) ultra-narrow spectrally selective sensitivity and 100 micro radians angle sensitivity. In addition, the volume Bragg grating also has properties of long-term stability, reliability and low loss and can be used as the frequency selective device in laser resonator.

Volume Bragg grating can be classified as transmitted type and reflective type. The reflective volume Bragg grating is the volume Bragg grating used in reflection condition, with which the diffracted light and the incident light intersects in the same side of volume Bragg grating. An extreme case of reflective volume Bragg grating is fold-back reflection, which is that the diffracted light exits along the opposite direction of the incident light. Thus, this kind of volume Bragg grating can be used as the output coupler of optical resonator of laser device. When a reflective volume Bragg grating is used as the output coupler, the light with the wavelength which is the same as the Bragg wavelength of the grating can be almost entirely reflected and the light with other wavelength can almost entirely transmit through the grating. The Bragg wavelength of volume Bragg grating is decided by the structure of periodic refractive index of grating. Thus, any spectral line in the gain spectrum can be selected out by adjusting the periodic structure parameter and the stimulated amplification occurs to form the laser output. According to the superior characteristics of volume Bragg grating above-mentioned, the reflective volume Bragg grating can select any required spectral line, including a certain spectral line in a closely adjacent spectral lines or a continuous spectrum from the gain spectrum with an extreme precision. With ultra-narrow bandwidth and high reflectivity on the Bragg wavelength, the volume Bragg grating can select the required wavelength from an intensive spectrum, a weak gain spectrum and even a continuous spectrum.

In this embodiment of the present invention, the Bragg wavelength (center wavelength) of the reflective volume Bragg grating is the same as the fundamental frequency laser. The Bragg wavelength of reflective Bragg volume grating is correspondent with the center wavelength of a certain discrete gain spectral line or a certain wavelength of continuous gain spectrum of gain medium 205. The surface of the reflective volume Bragg grating is coated with an anti-reflection film which is anti-reflective for the fundamental frequency laser and its second-harmonic. In this embodiment, the reflective volume Bragg grating, of which the Bragg wavelength is 1122.2 nm, the full width at half maximum is 0.18 nm, has a reflectivity above 99.5% at 1122.2 nm. In addition, the incident and exit surfaces of the reflective volume Bragg grating are coated with anti-reflection film which has reflectivity lower than 0.2% correspondingly with 1122.2 nm and 561.1 nm.

The focusing unit 202 is located between the pumping source 201 and the optical resonator, for focusing the pump light emitting from the pumping source 201 to the optical resonator. As shown in FIG. 2, the focusing unit 202 is located between the pumping source 201 and the first wave plate 203. The focusing unit 202 is preferably a self-focusing (Grin) lens or an optical convergence system.

In summary, the second embodiment as shown in FIG. 2 is an intra-cavity frequency-doubled solid-state laser with a flat-flat cavity structure. The solid-state laser can generate yellow green continuous laser 208 at 561.1 nm.

### The Second Embodiment

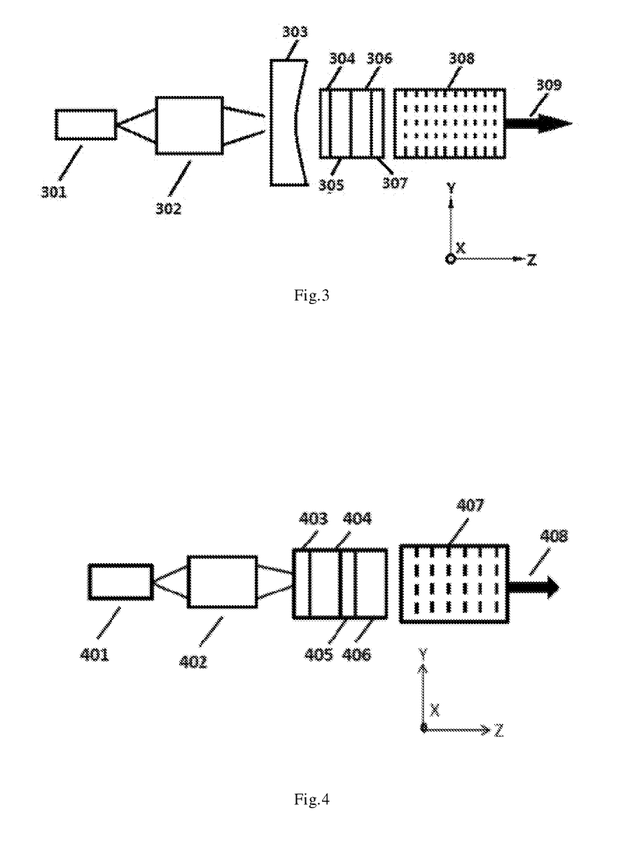

Please refer to FIG. 3, which shows a schematic diagram of the solid-state laser device according to the second embodiment of present invention. As shown in FIG. 3, the solid-state laser device based on a twisted-mode cavity and a volume grating comprises: a pumping source 301, a focusing unit 302 and an optical resonator. Wherein, the pumping source 301 and the focusing unit 302 are the same as that of the first embodiment as shown in FIG. 2. The difference from the first embodiment as shown in FIG. 2 is that the optical resonator further comprises a concave mirror 303 in this embodiment. Concave mirror 303 is served as a high-reflective mirror. The surface (incident surface) of concave mirror 303 which is near the pumping source 301 is flat and provided with an anti-reflective film, and the other side surface which is far away from the pumping source 301 is a concave surface and provided with a high reflective film, a partially reflective film and an anti-reflective film.

Specifically, the optical resonator comprises: a concave mirror 303, the first wave plate 304, a frequency doubling crystal 305, a gain medium 306, the second wave plate 307 and the output coupler 308.

In the embodiment shown in FIG. 3, the incident surface of the concave mirror 303 is coated with an anti-reflection film which has reflectivity lower than 0.5% at 808 nm, and the concave surface of the concave mirror 303 is coated with a high reflective film with reflectivity above 99.8% at 1122.2 nm and 561.1 nm, and coated with a partial reflective film with reflectivity lower than 40% at 946 nm and 1064 nm, and also coated with an anti-reflective film which has reflectivity lower than 1% at 808 nm. In this embodiment, the concave mirror 303, of which the incident surface is flat and the exit surface is concave, is a plano-concave lens, but not limited thereto, for example, it can be a concave mirror with a convex incident surface and a concave exit surface and the like.

The first wave plate 304 is different from that of the first embodiment as shown in FIG. 2 in that the first wave plate 304 in this embodiment is not served as a high reflective mirror and thus the surface (incident surface) which is near the pumping source 301 is not provided with high reflective film, partially reflective film and anti-reflective film. But the frequency doubling crystal 305, the gain medium 306 and the second wave plate 307 are all the same as that of the first embodiment as shown in FIG. 2. And preferably, the first wave plate 304, the frequency doubling crystal 305, the gain medium 306, and the second wave plate 307 are glued together by optical cement to reduce intra-cavity loss.

The output coupler 308 which is the same as that of the first embodiment as shown in FIG. 2, employs a reflective volume Bragg grating, which will not be repeated here.

In summary, the second embodiment shown in FIG. 3 is an intra-cavity frequency doubled solid-state laser with a flat-concave cavity structure. The solid-state laser can generate yellow green continuous laser 309 at 561.1 nm.

### The Third Embodiment

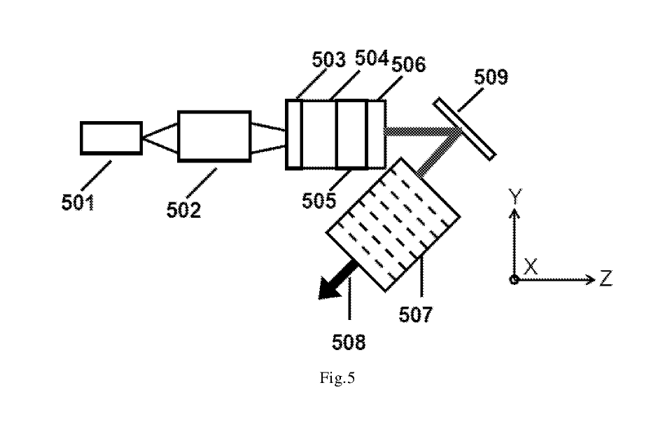

Please refer to FIG. 4, which shows a schematic diagram of the solid-state laser device according to the third embodiment of present invention. As shown in FIG. 4, the solid-state laser device based on a twisted-mode cavity and a volume grating comprises: a pumping source 401, a focusing unit 402 and an optical resonator. Wherein, the pumping source 401 and the focusing unit 402 are the same as that of the first embodiment as shown in FIG. 2. The difference from the first embodiment as shown in FIG. 2 is that the frequency doubling crystal 403 is placed outside of the twisted-mode cavity (not between the first wave plate 404 and the second wave plate 406) and close to the pumping source 401. The surface of frequency doubling crystal 403 which is near the pumping source 401 is provided with a high reflective film served as the cavity mirror.

Wherein, the frequency doubling crystal 403 needs to be a type I phase matching crystal. And then, the included angle between fast/slow axis of the first wave plate 404 and the second wave plate 406 which all employ the quarter-wave plates may be arbitrary. Further, the fundamental frequency laser is linearly polarized on the outer surface of the quarter-wave plate. If the polarization is parallel to the optical axis of the frequency doubling crystal, the optical electric field vector of the fundamental frequency laser will not generate polarization rotated, thus this kind of fundamental frequency laser can be used for second harmonic generation at its greatest extent.

Specifically, the optical resonator comprises: a frequency doubling crystal 403, the first wave plate 404, a gain medium 405, the second wave plate 406 and an output coupler 407.

In this embodiment, frequency doubling crystal 403 can be a BBO (Beta-BaB₂O₄) crystal, of which the azimuth angle is 0 degree, and the O axis is in the plane where the X-axis and Y-axis of the coordinate system shown in FIG. 4 and forms an included angle of 22.1 degree with Z-axis, which is just the phase matching angle at 1122.2 nm in the BBO crystal. The incident surface of the frequency doubling crystal 403 is coated with a high reflective film with reflectivity above 99.8% at 1122.2 nm and 561.1 nm, a partially reflective film with reflectivity below 40% at 946 nm and 1064 nm, and an anti-reflective film which has reflectivity below 1% at 808 nm.

The first wave plate 404 is different from that of the first embodiment as shown in FIG. 2 in that the first wave plate 404 in this embodiment is not served as a high reflective mirror and thus the surface (incident surface) which is near the pumping source 301 is not provided with high reflective film, partial reflective film and anti-reflective film. But the gain medium 405 and the second wave plate 406 are all the same as that of the first embodiment as shown in FIG. 2. And preferably, the frequency doubling crystal 403, the first wave plate 404, a gain medium 405, and the second wave plate 406 are glued together by optical cement to reduce intra-cavity loss.

In summary, the third embodiment shown in FIG. 4 is an intra-cavity frequency doubled solid-state laser with a flat-flat cavity structure. The solid-state laser can generate yellow green continuous laser 408 at 561.1 nm.

Further, in a variation embodiment, the frequency doubling crystal 403 may be placed outside of the twisted-mode cavity (not between the first wave plate 404 and the second wave plate 406) and far away from the pumping source 401. In this variation embodiment, the frequency doubling crystal 403 still needs to be a type I phase matching crystal. The first wave plate 404 is the same as that in the second embodiment and still used as a cavity mirror, of which the incident surface is coated with a high reflective film, while the incident surface of frequency doubling crystal 403 is not coated with a high reflective film. The frequency doubling crystal 403 still needs to be the type I phase matching crystal, and preferably can be a BBO (Beta-BaB₂O₄) crystal. This variation embodiment may be also implemented, which will not be repeated here.

### The Fourth Embodiment

Please refer to FIG. 5, which shows a schematic diagram of the solid-state laser device according to the fourth embodiment of present invention. As shown in FIG. 5, the solid-state laser device based on a twisted-mode cavity and a volume grating comprises: a pumping source 501, a focusing unit 502 and an optical resonator. The difference from the first embodiment as shown in FIG. 2 is that the optical resonator is a V-type cavity. Specifically, the optical resonator comprises: the first wave plate 503, a frequency doubling crystal 504, a gain medium 505, the second wave plate 506, an output coupler 507 and a reflective mirror 509. The direction of the pump light emitted from the pumping source 501 is different from that of the laser generated by the output coupler 507. As shown in FIG. 5, the reflective mirror 509 is at the side of the second wave plate 506 which is far away from the pumping source 501, and the output coupler 507 is placed under the first wave plate 503, the frequency doubling crystal 504, the gain medium 505 and the second wave plate 506. The reflective mirror has reflectivity above 99.9% at fundamental frequency and frequency doubling light. The light emitted from the second wave plate 506 is reflected by the reflective mirror 509 and then enters into the output coupler 507, of which the light path approximately presents in V-shape.

Further, the above-mentioned V-shape cavity can also be applied in embodiments as shown in FIG. 3 and FIG. 4. For example, as shown in FIG. 4, the reflective mirror 509 can be placed at the side of the second wave plate 406 which is far away from the pumping source 401. The light emitted from the second wave plate 406 is reflected by the reflective mirror 509 and then enters into the output coupler 407 with presenting in V-shape. No repeated here.

In summary, the fourth embodiment shown in FIG. 5 is an intra-cavity frequency-doubling solid-state laser with a V-shape cavity structure. The solid-state laser can generate yellow green continuous laser 508 at 561.1 nm.

In conclusion, these embodiments of the present invention mentioned above describe a solid-state laser device based on a twisted-mode cavity and a volume grating, which combines a twisted-mode cavity and a reflective volume Bragg grating to realize the single longitudinal mode operation and narrow line-width output. Wherein, the twisted-mode cavity can be used for eliminating the phenomenon of spatial hole burning, and the reflective volume Bragg grating can be used as an output coupler and select the required wavelength in very high accuracy. That is to say, narrow line-width property is realized by using the reflective volume grating as an output coupler, and single longitudinal mode operation can be guaranteed by combining the twisted-mode cavity and the reflective volume grating, and using the twisted-mode cavity, instead of the standing wave cavity, can effectively eliminate spatial hole burning to ensure the single longitudinal mode operation.

It should be noted that, although the twisted-mode cavity and the reflective volume Bragg grating pertain to prior art, the present invention combines the twisted-mode cavity and the reflective volume Bragg grating to implement that any wavelength can be selected in any gain spectrum for laser oscillation, and also to ensure a stable single longitudinal mode operation and narrow line-width output, with which all the properties of ring resonator laser in larger volume can be realized in a smaller and more compact structure. In addition, there is a frequency doubling crystal inserted in the optical resonator, thus the second harmonic can be generated without “green noise”. The solid-laser device has advantages of high stability and reliability, good beam quality, low noise and so on.

What is claimed is:

1. A solid-state laser device based on a twisted-mode cavity and a volume grating, comprising:
a pumping source for emitting pump light;
an optical resonator, which comprises:
a cavity mirror, which is a high reflective mirror for introducing said pump light into said optical resonator;
an output coupler, which is a reflective volume Bragg grating spaced away from said end mirror;
a twisted-mode cavity, which includes:
a first wave plate, located at one side close to said pumping source;
a second wave plate, located at another side far away from said pumping source;
a gain medium, located between said first wave plate and said second wave plate for generating a fundamental frequency laser;
and a focusing unit, located between said pumping source and said optical resonator for focusing said pump light emitting from said pumping source to said optical resonator.

2. The solid-state laser device based on a twisted-mode cavity and a volume grating according to claim 1, wherein, said cavity mirror has reflectivity above 99.8% for the selected fundamental frequency laser and second harmonic light thereof.

3. The solid-state laser device based on a twisted-mode cavity and a volume grating according to claim 1, wherein, said cavity mirror is a lens or an optical element, of which the incident surface is provided with a high reflective film.

4. The solid-state laser device based on a twisted-mode cavity and a volume grating according to claim 3, wherein, the lateral surface of said first wave plate which is near said pumping source is provided with a high reflective film, and said first wave plate serves as said cavity mirror.

5. The solid-state laser device based on a twisted-mode cavity and a volume grating according to claim 3, wherein, said optical resonator further comprises a frequency doubling crystal for converting said fundamental frequency light to its second harmonics.

6. The solid-state laser device based on a twisted-mode cavity and a volume grating according to claim 5, wherein, said gain medium, said frequency doubling crystal, said first wave plate and said second wave plate are glued together by optical cement to reduce intra-cavity loss.

7. The solid-state laser device based on a twisted-mode cavity and a volume grating according to claim 5, wherein, said frequency doubling crystal is placed between said first wave plate and said gain medium or between said gain medium and said second wave plate.

8. The solid-state laser device based on a twisted-mode cavity and a volume grating according to claim 5, wherein, said frequency doubling crystal is located outside of the twisted-mode cavity.

9. The solid-state laser device based on a twisted-mode cavity and a volume grating according to claim 8, wherein, said frequency doubling crystal is located outside of said twisted-mode cavity and at the side near said pumping source, and said frequency doubling crystal, as said cavity mirror, is provided with a high reflective film on its lateral surface near said pumping source.

10. The solid-state laser device based on a twisted-mode cavity and a volume grating according to claim 8, wherein, said frequency doubling crystal is a type I phase matching crystal.

11. The solid-state laser device based on a twisted-mode cavity and a volume grating according to claim 1, wherein, said cavity mirror is a concave mirror, and the lateral surface of said concave mirror which is near said pumping source is provided with an anti-reflection film, and the lateral surface of said concave mirror which is far away from said pumping source is concave and provided with a high reflective film, a partially reflective film, and an anti-reflection film.

12. The solid-state laser device based on a twisted-mode cavity and a volume grating according to claim 1, wherein, said optical resonator is a V-type resonator, and further comprises a reflective mirror via which the light is reflected to said output coupler.

13. The solid-state laser device based on a twisted-mode cavity and a volume grating according to claim 1, wherein, both said first wave plate and said second wave plate are quarter wave plates.

14. The solid-state laser device based on a twisted-mode cavity and a volume grating according to claim 5, wherein, the direction of fast/slow axis of said first wave plate and said second wave plate are adapted with the phase matching type and the direction of optical axis of said frequency doubling crystal.

15. The solid-state laser device based on a twisted-mode cavity and a volume grating according to claim 1, wherein, said pumping source is a solid state laser, a semiconductor laser or a gas laser.

16. The solid-state laser device based on a twisted-mode cavity and a volume grating according to claim 1, wherein, the reflective Bragg wavelength of said reflective volume Bragg grating is the same as that of the fundamental frequency laser.

17. The solid-state laser device based on a twisted-mode cavity and a volume grating according to claim 1, wherein, the reflective Bragg wavelength of said reflective volume Bragg grating is correspondent to the center wavelength of one separated gain spectral line of said gain medium or one wavelength of continuous gain spectrum of said gain medium.

18. The solid-state laser device based on a twisted-mode cavity and a volume grating according to claim 1, wherein, said reflective volume Bragg grating has a reflectivity above 99.5% for the selected fundamental frequency laser.

19. The solid-state laser device based on a twisted-mode cavity and a volume grating according to claim 1, wherein, the surface of said reflective volume Bragg grating is coated with a film which is anti-reflective for the selected fundamental frequency laser and second harmonic light thereof.

20. The solid-state laser device based on a twisted-mode cavity and a volume grating according to claim 1, wherein, said gain medium has separated gain spectral lines or continuous gain spectrum.
